(19) United States
(12) Patent Application Publication
(10) Pub. No.: US 2019/0184352 A1
(43) Pub. Date: Jun. 20, 2019

(54) MODULAR STIRRER

(71) Applicant: ZETA GMBH, Lieboch (AT)

(72) Inventor: Erwin TRUMMER, St. Stefan im Rosental (AT)

(21) Appl. No.: 16/322,172

(22) PCT Filed: Aug. 1, 2017
(86) PCT No.: PCT/EP2017/069391

§ 371 Date: Jan. 31, 2019

(30) Foreign Application Priority Data
Aug. 1, 2016 (AT) A 50698/2016

(51) Int. Cl. B01F 13/08; B01F 15/00; B01F 7/16

(52) U.S. Cl. CPC B01F 13/0863; B01F 7/1695; B01F 15/0072

(57) ABSTRACT

A modular stirrer having a drive unit, a stirrer unit, and a magnetic coupling. The magnetic coupling is arranged between the drive unit and the stirrer unit and has a cylindrical cavity, drive magnets as well as stirrer unit magnets, and the drive magnets are connected to the drive unit and the stirrer unit magnets are connected to the stirrer unit and arranged radially about the cavity. The cavity is open at the opposite end in the opened state of the magnetic coupling, and the drive magnets may be inserted into the cavity of the magnetic coupling for closing the magnetic coupling for coupling of drive unit and stirrer unit and may be arranged in a plane one with the stirrer unit magnets. The magnetic coupling has a quick-release closure, which closes the cavity upon closing the magnetic coupling and creates a connection of drive unit and stirrer unit.

The invention relates to a modular stirrer having a drive unit, a stirrer unit as well as a magnetic coupling, wherein the magnetic coupling is arranged between the drive unit and the stirrer unit and has a cylindrical cavity, drive magnets as well as stirrer unit magnets, wherein the drive magnets are connected to the drive unit and the stirrer unit magnets are connected to the stirrer unit and arranged radially about the cavity, wherein the cavity is open at the end essentially opposite to the stirrer unit in the opened state of the magnetic coupling, and wherein the drive magnets may be inserted into the cavity of the magnetic coupling for closing the magnetic coupling for coupling of drive unit and stirrer unit and may be arranged essentially in a plane one with the stirrer unit magnets.

Such a modular stirrer is used for example in the food industry, in particular in the field of fruit preparations.

Fruit mixtures are in general high-viscous fluids, which contain fruit pieces. These are in general filled at a filling site into stainless-steel containers, which upon filling are transported for further use to the next production site. The containers are stored at the filling site or production site, respectively, in a rather space-saving way until filling or further processing, respectively.

After use, the containers are cleaned, aseptically recycled, then being available for a new filling process. Also here, a possibly space-saving storage of cleaned or un-cleaned, respectively, containers is necessary. In particular in the case of low-viscous fruit mixtures, the fruit pieces, however, will deposit on the bottom of the containers, whereby the mixture will become inhomogeneous. Thus it is necessary, before further processing, to homogenize the mixture again within the container, without opening the container, as the fruit mixture is to be maintained sterile.

Thereto, there have been available on the market containers having integrated stirrers, wherein these are provided with a floating ring seal. For sterile processes, however, this represents a possible cause of risk, as in the case of wear and tear of the seal, there is given the possibility of contamination of the product. This would lead to the final product, which is produced from the fruit mixture, having to be discarded.

The EP 1 748 201 B1 discloses a magnetic stirrer, which has a magnetic coupling between drive unit and stirrer, whereby the floating ring seal may be omitted, and whereby the risk of contamination of the product through the seal is eliminated. The drive system is secured to the container by means of a number of screws in the EP 1 748 201 B1.

The US 2004/076076 A1 discloses a stirrer having a magnetic coupling.

The U.S. Pat. No. 5,478,149 A discloses a magnetic stirrer having a magnetic coupling with a quick-release closure.

Such constructions have shown the disadvantage that the containers have significant space requirements due to their form, thus increasing the storage costs. The drive system connected to the containers further causes increased acquisition costs, limiting the serviceability of the containers.

It is the task of the present invention to form a modular stirrer, which prevents the disadvantages of the constructions mentioned above.

According to the invention, the present task is solved by the magnetic coupling having a quick-release closure, which closes the cavity upon closing the magnetic coupling and which creates a connection between drive unit and stirrer unit.

The stirrer is integrated in the container lid, which matches different container sizes.

Because of the configuration of the stirrer according to the invention, in particular because of the modular set-up thereof in connection to the easy-release connection between container and drive unit, the container is independent of the drive unit. In this way, there is obtained the advantage that one drive unit may be used for a plurality of containers. As a consequence, the number of drive units necessary for a particular number of containers will decrease, wherein the drive units may remain at the respective production site. In the case of a malfunction of a drive unit, this may further be simply replaced, whereby shut-down times in the production process are reduced. It is in particular advantageous that in this way also the service life of the containers will be increased.

It is further advantageous that the acquisitions costs of the containers are reduced by such a construction by means of the drive unit independent of the respective container.

A further advantage of the present invention is that due to the simple disassembly of the drive unit from the containers there will be enabled stapling of the containers, whereby a space-saving storage may be ensured.

It is further advantageous that the cleaning process of the containers is essentially facilitated by the elimination of a fixedly connected drive unit.

Advantageous embodiments of the modular stirrer according to the invention as well as alternative embodiment variants are explained in greater detail by way of the figures in the following.

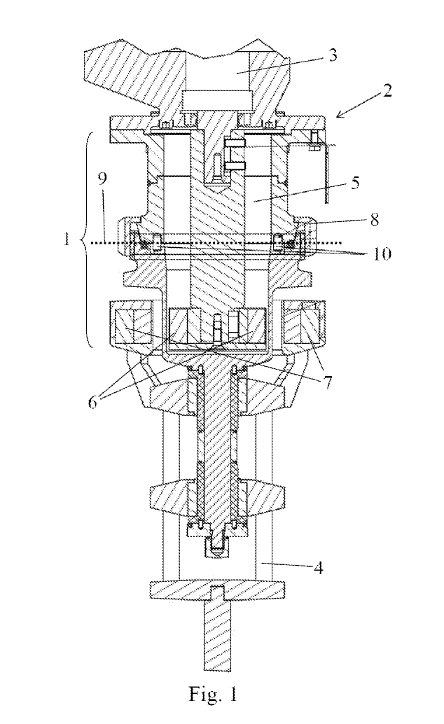

FIG. 1 shows a sectional view through the magnetic coupling of a modular stirrer according to the invention in a front view.

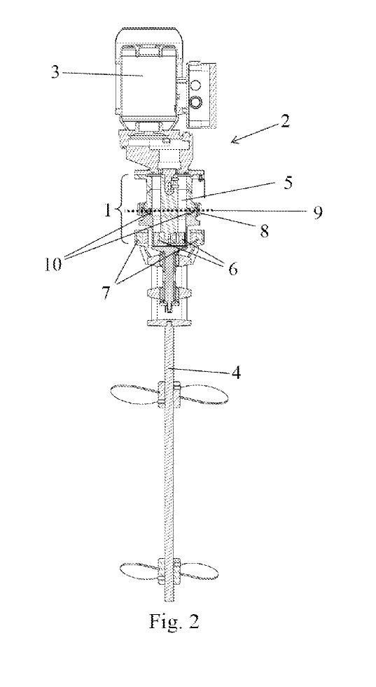

FIG. 2 shows a sectional view through a modular stirrer according to the invention in a front view.

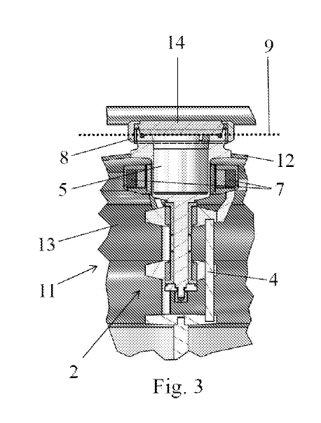

FIG. 3 shows a sectional view through a modular stirrer, which is integrated in a container lid, having a separate drive unit and a mounted closure, in a front view.

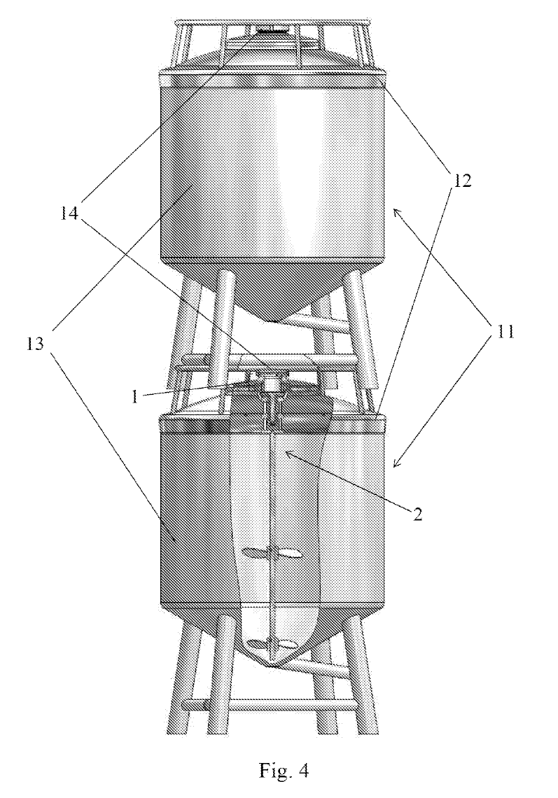

FIG. 4 shows two containers having a modular stirrer according to the invention with disassembled drive unit and mounted closure in the stapled state in a front view.

FIG. 1 shows a preferred embodiment variant of a magnetic coupling 1 of a modular stirrer 2 according to the invention in the closed state. The stirrer 2 consists of a drive unit 3, a stirrer unit 4 as well as the magnetic coupling 1 disposed there between. The drive unit 3 and the stirrer unit 4 are shown only in portions in FIG. 1 for a better illustration of the magnetic coupling 1. The magnetic coupling 1 is composed of a cavity 5, in which there are situated drive magnets 6 in the closed state of the magnetic coupling 1. Stirrer unit magnets 7 are arranged radially about the cavity 5 in the plane of the drive magnets 6. In the closed state of the magnetic coupling 1, the torque of the drive unit 3 is transferred due to the magnetic attraction of the drive magnets 6 and the stirrer unit magnets 7 from the drive unit 3 to the stirrer unit 4.

Upon opening of the magnetic coupling 1, the drive magnets 6 are removed from the cavity 5, wherein this is opened for this purpose by means of a quick-release closure 8.

The connection between drive unit 3 and stirrer unit 4 is realized upon closing the magnetic coupling 1, wherein the drive magnets 6 are inserted into the cavity 5 and arranged in the plane of the stirrer unit magnets 7. In this way, the cavity 5 is closed by means of the quick-release closure 8.

In this way there is obtained the advantage that the drive unit 3 may be connected to the stirrer unit 4 and removed from this in a rather simple way. The use of a magnetic coupling 1 is advantageous as this does not require any additional seals, which represent a potential cause of risk for the sterility of the container content.

The quick-release closure 8 may be one from various quick-release closures, wherein there is preferably used a bayonet coupling, a union nut, a shank hose coupling or a TC closure.

The use of these quick-release closures is especially advantageous as these are available on the market in a high number and do not require any complex or special-purpose tool in order to being opened or closed, respectively. In this way, there is additionally facilitated the handling thereof.

The magnetic coupling 1 depicted in FIG. 1 has a separating plane 9, in which the magnetic coupling 1 may be separated. Therein, there is arranged a number of pins 10, which engage in respective recesses of the opposite magnetic coupling part upon closing the magnetic coupling 1.

In this way there is obtained the advantage that the magnetic coupling 1 is additionally reinforced by the pins 10 against possibly occurring loads such as vibrations or transverse loads.

The modular stirrer 2 depicted in FIG. 2 in a sectional view in the front plane is, as depicted in FIG. 4, preferably a part of a container 11, wherein this is composed of a container lid 12 and a container body 13. FIG. 2 illustrates the entire modular stirrer 2 in a preferred embodiment with complete drive unit 3 and stirrer unit 4, which are depicted in FIG. 1 only in portions. The magnetic coupling 1 of the modular stirrer 2 is, as depicted in FIG. 3 in details, integrated in the container lid 12, wherein this encloses the cavity 5 of the magnetic coupling 1 underneath the separating plane 9 of the magnetic coupling 1. By means of this set-up there is obtained the advantage that the modular stirrer 2 may be integrated in containers 11 of different sizes due to the combination of uniform container lid 12 with container bodies 13 of different holding capacities.

FIG. 3 shows a sectional view in the front plane of a modular stirrer 2 in a preferred embodiment variant, wherein the drive unit 3 has been removed by separation of the magnetic coupling 1. The modular stirrer 2 is enclosed by the container lid 12, which is depicted only in portions like the stirrer unit 4. The cavity 5 of the magnetic coupling 1 is shown in FIG. 3 in the closed state in a front view. Therefore, in the separated state of the magnetic coupling 1, there is mounted a closure 14 onto the separating plane 9 of the magnetic coupling 1.

In this way there is obtained the advantage that the cavity 5 of the magnetic coupling 1 will not be contaminated by mounting the closure 14.

The closure 14 may be one of various closures, wherein there is preferably used a bayonet coupling, a union nut, a shank hose coupling or a TC closure.

The use of these closures is especially advantageous, as these are available on the market in a high number and do not require any complex, special-purpose tool in order to being opened or closed, respectively. In this way, there is additionally facilitated the handling thereof.

FIG. 4 show two containers 11 having a modular stirrer 2 according to the invention with separated magnetic coupling 1 and closure 14 in a front view, which are stapled one upon another. The lower of the two containers 11 is shown in a cut-open illustration in order to illustrate the modular stirrer 2 integrated therein.

By way of the possibility of removing the drive unit 3 from the containers 11, it is possible, as shown in FIG. 4, to staple these one upon another.

In this way there is given the advantage that there will be necessary smaller space requirements for the storage of containers 11, whereby the storage costs will be reduced.

The modular stirrer 2 disclosed herein may be used, apart from the food industry, in all fields, in which it is advantageous for the container content to remain sterile and in which there are not used additional seals for the stirrer 2. These include, for example, the pharmaceutical industry and the chemical industry. Further fields of application will be obvious for those skilled in the art from this exemplary reference.

1.-5. (canceled)

6. A modular stirrer having a drive unit, a stirrer unit as well as a magnetic coupling, wherein the magnetic coupling is arranged between the drive unit and the stirrer unit and has a cylindrical cavity, drive magnets as well as stirrer unit magnets, wherein the drive magnets are connected to the drive unit and the stirrer unit magnets are connected to the stirrer unit and arranged radially about the cavity, wherein the cavity is open at the end essentially opposite to the stirrer unit in the opened state of the magnetic coupling, and wherein the drive magnets are configured to be inserted into the cavity of the magnetic coupling to close the magnetic coupling to couple the drive unit and stirrer unit and may be arranged essentially in a common plane with the stirrer unit magnets, wherein the magnetic coupling has a quick-release closure, which closes the cavity upon closing the magnetic coupling and creates a connection of drive unit and stirrer unit, wherein in the wall of the cavity there are arranged pins in a partition plane of the magnetic coupling, which engage in respective recesses of the opposite part of the magnetic coupling in the course of coupling.

7. A modular stirrer according to claim 6, wherein the quick-release closure is a quick-release closure of the following group: a bayonet coupling, a union nut, a shank hose coupling, a TC closure.

8. A modular stirrer according to claim 6, wherein the cavity is configured to be closed by a closure in the opened state of the magnetic coupling.

9. A modular stirrer according to claim 8, wherein the closure is a closure of the following group: a bayonet coupling, a shank hose coupling, a screw-lid, a TC closure.

10. A container configured to hold heterogeneous, high-viscous fluids with solid particles contained therein, the container comprising a container lid and a container body, wherein the container lid has a modular stirrer according to claim 6.
